(19) United States
(12) Patent Application Publication
(10) Pub. No.: US 2026/0296397 A1
(43) Pub. Date: Oct. 1, 2026

(54) HYBRID VEHICLE

(71) Applicant: Isuzu Motors Limited, Yokohama-shi (JP)

(72) Inventor: Sei KAMAKURA, Fujisawa-shi (JP)

(73) Assignee: Isuzu Motors Limited, Yokohama-shi (JP)

(21) Appl. No.: 19/629,013

(22) Filed: Mar. 26, 2026

(30) Foreign Application Priority Data
Mar. 31, 2025 (JP) 2025-058430

(51) Int. Cl. B60W 20/13; B60K 6/26; B60K 6/40; B60W 10/06; B60W 10/30; B60W 20/12; F01N 3/20; G07C 5/04

(52) U.S. Cl. CPC B60W 20/13; B60K 6/26; B60K 6/40; B60W 10/06; B60W 10/30; B60W 20/12; F01N 3/2013; G07C 5/04; B60W 2510/244; B60W 2555/20; B60W 2710/06; B60W 2710/244; B60W 2710/305; B60Y 2200/92; B60Y 2300/91; B60Y 2400/112; B60Y 2400/446; B60Y 2400/60

(57) ABSTRACT

A hybrid vehicle including: an engine; a battery; a generator for charging the battery; a catalyst that purifies exhaust gas of the engine; a heating device that heats the catalyst by electric power of the battery; and a processor that controls driving of the generator, in which the processor controls the driving of the generator such that an amount of charge of the battery is equal to or greater than a predetermined threshold value before arrival at a destination where parking for a predetermined duration or longer is expected, and the threshold value is an amount of charge capable of supplying electric power necessary for heating, by the heating device, the catalyst cooled by the parking for the predetermined duration or longer.

### RELATED APPLICATIONS

This application claims the benefit of priority of Japanese Patent Application No. 2025-058430 filed on March 31, 2025, the contents of which are all incorporated herein by reference in their entirety.

### TECHNICAL FIELD

The present disclosure relates to a hybrid vehicle.

### BACKGROUND ART

A vehicle that travels by driving an engine is provided with a catalyst that purifies exhaust gas. In the case of a diesel engine, an exhaust gas purification device (DPD: Diesel Particulate Diffuser) that collects and removes soot in exhaust gas by combustion, and a selective catalytic reduction device (SCR: Selective Catalytic Reduction) that decomposes nitrogen oxides in exhaust gas are provided in the middle of the exhaust pipe. The DPD includes a diesel oxidation catalyst (DOC) and a diesel particulate filter (DPF), and the SCR includes a nitrogen oxide reduction catalyst (SCR catalyst), an ammonia slip catalyst (ASC), and a urea injector.

The diesel oxidation catalyst and the nitrogen oxide reduction catalyst become active at a predetermined temperature (activation start temperature) or higher; therefore, a heating device that heats the catalyst is provided in the vehicle, and the catalyst is heated when the catalysts are cooled, such as at the time of engine start. In the case of a hybrid vehicle, a battery that supplies electric power to a drive motor may supply electric power to the heating device.

Because the temperatures of the catalysts are lowered at the time of engine start after long-term parking, it is necessary to warm the catalysts to the activation start temperature by the heating device. Thus, there is a technique of charging a battery before parking to secure power necessary for heating the catalysts such that there is no power shortage at the time of engine start (Patent Literature (hereinafter, referred to as PTL) 1). In this technique, when the amount of charge of the battery is lower than a predetermined threshold value at the time of parking, the battery is charged by generating power by driving the engine, and then the engine is stopped.

### Citation List

### Patent Literature

PTL 1

Japanese Patent Application Laid-Open No. 2022-166400

### SUMMARY OF INVENTION

### Technical Problem

In the conventional technique, when parking, that is, when stopping the engine and the motor in a parking space, the amount of charge of the battery is measured and charged as necessary, and thus the engine is driven to generate power while the vehicle stops in the parking space, which causes a problem in that it takes time until the engine is stopped and exhaust gas is continuously discharged while the vehicle stops even in a place where idling is not desirable, such as in a public parking lot. In addition, the engine may be continuously operated for charging even when short-term parking in which the catalyst is not cooled much and the catalyst does not need to be heated at the time of engine start, which may lead to deterioration in fuel economy.

An object of the present disclosure is to provide a hybrid vehicle that does not need to continue engine operation to charge the battery after stopping, and does not need to charge the battery when short-term parking does not require securing power for heating the catalyst.

### Solution to Problem

A hybrid vehicle of the present disclosure includes: an engine; a battery; a generator for charging the battery; a catalyst that purifies exhaust gas of the engine; a heating device that heats the catalyst by electric power of the battery; and a processor that controls driving of the generator, in which the processor controls the driving of the generator such that an amount of charge of the battery is equal to or greater than a predetermined threshold value before arrival at a destination where parking for a predetermined duration or longer is expected, and the threshold value is an amount of charge capable of supplying electric power necessary for heating, by the heating device, the catalyst cooled by the parking for the predetermined duration or longer.

### Advantageous Effects of Invention

When long-term parking is expected, the battery is charged during traveling before arriving at a destination, so that the amount of charge necessary for heating the catalyst by the heating device can be secured before arriving at the destination, and it is not necessary to continuously operate the engine after stopping. This makes it possible to avoid the engine being continuously operated against the will of the driver in an environment where idling operation is not desirable, such as in a public parking lot. In addition, charging required for heating the catalyst by the heating device is not performed in the case of short-term parking in which it is not necessary to heat the catalyst at startup after parking, so that unnecessary charging can be avoided, thereby improving fuel economy and suppressing deterioration of the battery.

### BRIEF DESCRIPTION OF THE SEVERAL VIEW OF THE DRAWINGS

FIG. 1 is a diagram illustrating a configuration of a hybrid vehicle;

FIG. 2 is a diagram illustrating a configuration of an exhaust system of an engine;

FIG. 3 is a diagram illustrating an overview of an operation of the hybrid vehicle;

FIG. 4 is a flowchart of charging control of the battery; and

FIG. 5 is a diagram illustrating a time transition of each parameter.

### DESCRIPTION OF EMBODIMENTS

Hereinafter, embodiments of the present disclosure will be described with reference to the drawings. It should be noted that all embodiments described below are specific examples of the present disclosure. Therefore, each component, a disposition position of each component, a connection form, and the like shown in the following embodiment are merely examples, and do not limit the spirit of the present disclosure. In addition, each drawing is a schematic diagram and is not necessarily strictly illustrated. In each drawing, the same reference numerals are assigned to substantially the same configurations, and redundant descriptions may be omitted or simplified.

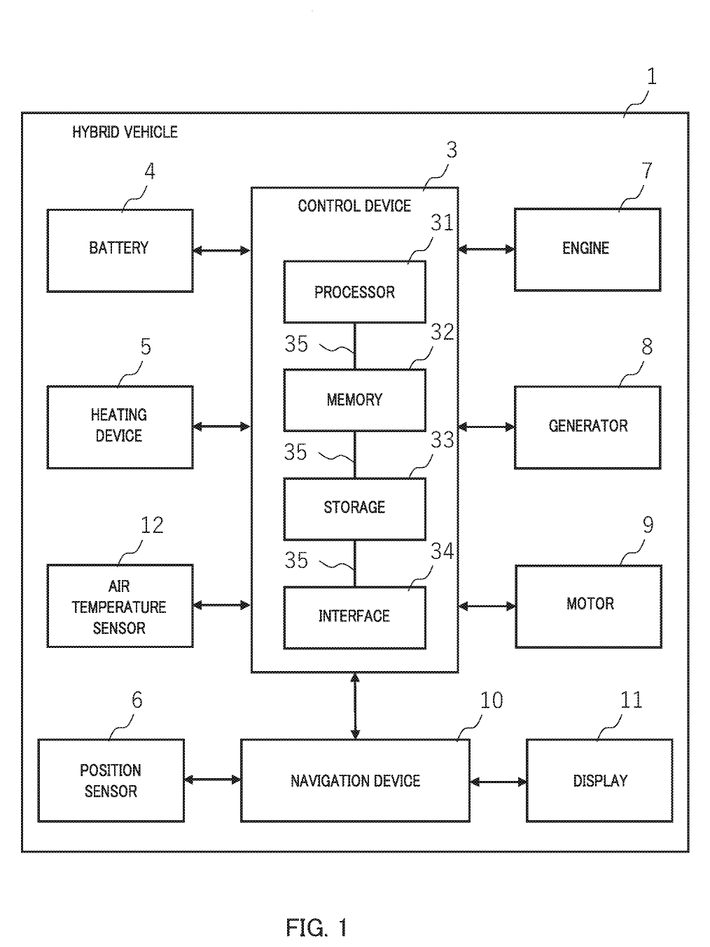

FIG. 1 illustrates a configuration of hybrid vehicle 1. Hybrid vehicle 1 includes engine7 and motor 9 for driving. Motor 9 is driven by electric power supplied from battery 4. Battery 4 is charged by electric power supplied from generator 8. Generator 8 is driven by engine 7. Furthermore, battery 4 may be charged by regenerative energy of motor 9 generated during deceleration.

Hybrid vehicle 1 includes navigation device 10. Navigation device 10 performs route guidance to a set destination or the like. When the user inputs the destination to navigation device 10, a route to the destination is calculated from the vehicle position acquired by position sensor 6 and the map data, and the route is displayed on display 11 to guide the way.

Hybrid vehicle 1 includes control device 3 that controls the driving of engine 7, generator 8, motor 9, and heating device 5 and that controls the charging of battery 4.

Control device 3 includes: processor 31 such as a central processing unit (CPU) as a computing device; memory 32 such as a non-volatile memory (e.g., read only memory (ROM)) or a volatile memory (e.g., random access memory (RAM)) as a main memory; storage 33 such as a hard disk drive (HDD) or a solid state drive (SSD) as an auxiliary memory; and interface 34 as an input/output circuit, which are connected to each other via bus 35. Processor 31 controls the driving of engine 7, generator 8, motor 9, and heating device 5 and controls the charging of battery 4 while temporarily storing data in memory 32 in accordance with a control program stored in storage 33.

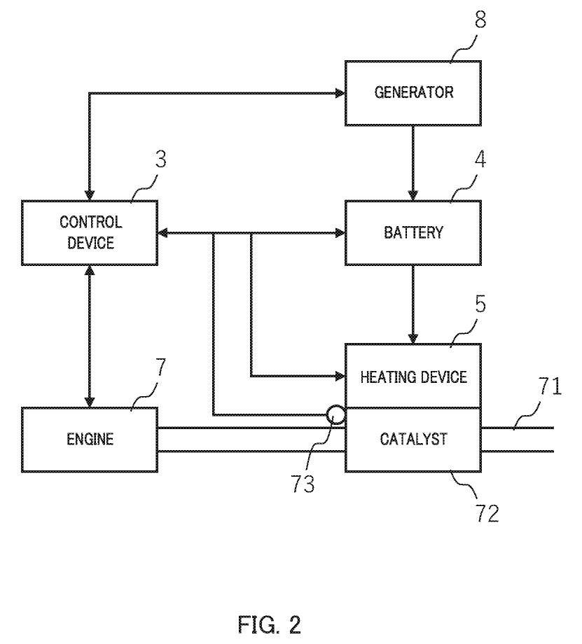

Catalyst 72 and heating device 5 of hybrid vehicle 1 will be described with reference to FIG. 2. FIG. 2 schematically illustrates catalyst 72 and heating device 5. Exhaust gas discharged from engine 7 is released to the outside of the vehicle through exhaust pipe 71. Catalyst 72 that purifies exhaust gas is provided in the middle of exhaust pipe 71. Catalyst 72 is, for example, a diesel oxidation catalyst or a nitrogen oxide reduction catalyst. Catalyst 72 is provided with heating device 5.

In the case of a diesel engine, catalyst 72 is a catalyst of an exhaust gas purification device that includes, in the middle of exhaust pipe 71, an exhaust gas purification device (DPD: Diesel Particulate Diffuser) that collects and removes soot in exhaust gas by combustion, and a selective catalytic reduction device (SCR: Selective Catalytic Reduction) that decomposes nitrogen oxides in exhaust gas. The DPD includes a diesel oxidation catalyst (DOC) and a diesel particulate filter (DPF), and the SCR includes a nitrogen oxide reduction catalyst (SCR catalyst), an ammonia slip catalyst (ASC), and a urea injector. In addition, catalyst 72 is provided with temperature sensor 73 that detects the temperature of catalyst 72.

Heating device 5 may be a heater that is installed in exhaust pipe 71 to heat the exhaust gas and that heats catalyst 72 with the heated exhaust gas, or may be a heater that is installed adjacent to catalyst 72 to heat catalyst 72. In addition, heating device 5 may be an electric catalyst that heats a carrier supporting catalyst 72 by passing current through the carrier.

Heating device 5 is supplied with electric power from battery 4. Battery 4 supplies electric power to motor 9 for driving, but may be an auxiliary battery that is provided separately from the battery for driving. Battery 4 is charged by electric power generated by generator 8. Control device 3 drives engine 7 and generator 8 to charge battery 4. In addition, control device 3 supplies the electric power of battery 4 to heating device 5 to generate heat, and heats catalyst 72. Control device 3 may control heating device 5 based on the temperature of catalyst 72 detected by temperature sensor 73 to heat catalyst 72.

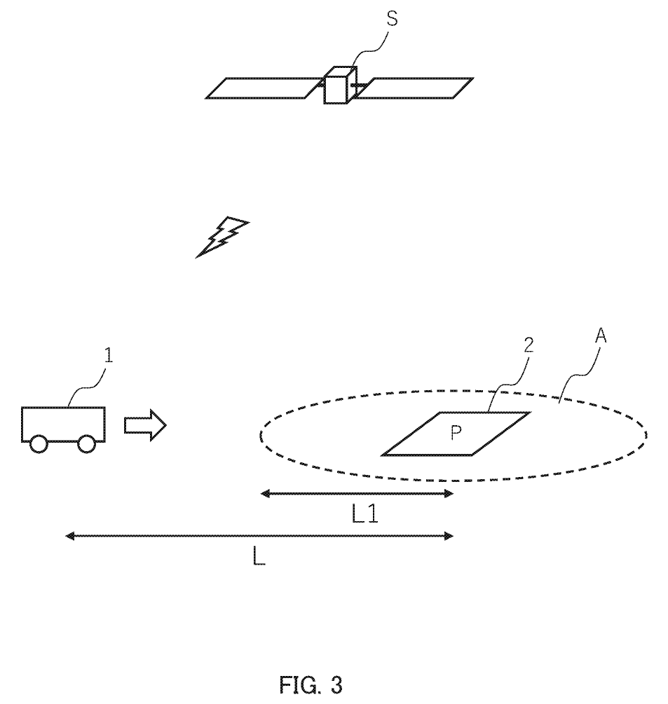

An overview of an operation of hybrid vehicle 1 of the present disclosure will be described with reference to FIG. 3. FIG. 3 schematically illustrates a state in which hybrid vehicle 1 is traveling toward destination 2. Hybrid vehicle 1 travels toward destination 2 where long-term parking is expected. The destination where long-term parking is expected is, for example, a parking lot of a business office of a transport vehicle, a parking lot of a home of a private car, or the like, and is a parking lot or the like where the catalyst warmed during traveling is expected to be at a predetermined temperature or lower by stopping the engine and parking. Here, the predetermined temperature is preferably an activation start temperature.

Hybrid vehicle 1 travels toward destination 2 along a travel route indicated by navigation device 10 while recognizing the vehicle position by communicating with GPS satellite S. When distance L to destination 2 approaches L1, control device 3 of hybrid vehicle 1 acquires the state of charge of battery 4, and control device 3 controls engine 7 and/or generator 8 to charge battery 4 such that the state of charge exceeds threshold value P1 at a point in time when hybrid vehicle 1 arrives at destination 2. Charging area A may be defined around destination 2 in advance, and battery 4 may be charged when hybrid vehicle 1 enters charging area A. This allows for appropriate charging without calculating the distance from the current position to the destination.

Threshold value P1 is a value indicating a state of charge sufficient for hybrid vehicle 1 to heat, by heating device 5, catalyst 72 that has been cooled, after long-term parking. Threshold value P1 is set as a state of charge that allows hybrid vehicle 1 to secure the charge amount necessary for traveling and further heat catalyst 72. Threshold value P1 may be set to different values depending on, for example, the outside air temperature acquired by air temperature sensor 12. In addition, threshold value P1 may be set according to a weather forecast or a season. That is, when the outside air temperature is low or when the outside air temperature is predicted to be low due to a weather forecast, the season being winter, or the like, the temperature of catalyst 72 becomes lower, so that threshold P1 may be set higher than in the case where the outside air temperature is high. Accordingly, an appropriate amount of charge can always be secured regardless of the outside air temperature.

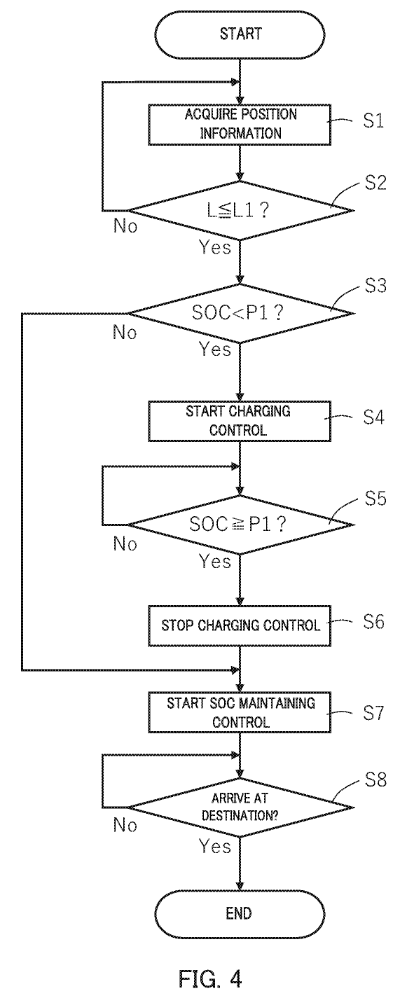

A process executed by control device 3 of hybrid vehicle 1 of the present disclosure will be described with reference to the flowchart illustrated in FIG. 4. The flowchart illustrated in FIG. 4 represents a series of processes in which processor 31 of control device 3 controls the charging of battery 4 of hybrid vehicle 1 in accordance with the control program. First, processor 31 acquires the position information of hybrid vehicle 1 detected by position sensor 6 (Step S1). The position information is acquired by, for example, position sensor 6 receiving a signal from GPS satellite S.

Processor 31 determines whether hybrid vehicle 1 has approached within predetermined distance L1 to destination 2 based on the acquired position information (Step S2). Destination 2 is a place expected to involve long-term parking, such that catalyst 72 may be cooled due to the long-term parking and therefore require heating by heating device 5 at startup. The destination set in navigation device 10 may be acquired as destination 2, or a place set and stored in storage 33 in advance by the user as a place where long-term parking is expected may be acquired as destination 2. In addition, navigation device 10 may store a travel record including a past parking location and a parking duration at the parking location, and acquire, as destination 2, a parking location where the parking duration is equal to or longer than a predetermined parking duration. The distance to destination 2 may be acquired by calculating a straight-line distance from the current position to destination 2 or may be acquired by calculating a distance along the travel route from the current position to destination 2 based on map information and travel route information of navigation device 10.

Predetermined distance L1 is set as a distance that allows battery 4 to be charged while hybrid vehicle 1 travels predetermined distance L1 to secure electric power necessary for heating, by heating device 5, catalyst 72 that has been cooled. Predetermined distance L1 is set as a distance sufficient for charging battery 4 to threshold value P1 during traveling, and is, for example, 3 km. Predetermined distance L1 is determined in consideration of the capacity of battery 4, the power consumption of heating device 5, the capacity of generator 8, the amount of regenerative energy predicted by a downhill slope or the like, the outside air temperature, and the like.

When the distance to destination 2 has not approached within predetermined distance L1 (No in Step S2), processor 31 continues to acquire the position information (returning to Step S1) and continues to monitor until the distance to destination 2 approaches L1.

On the other hand, when the distance to destination 2 has approached within predetermined distance L1 (Yes in Step S2), processor 31 determines whether an SOC indicating the state of charge of battery 4 is less than threshold value P1 (Step S3). Threshold value P1 is set as a state of charge sufficient for hybrid vehicle 1 to heat, by heating device 5, catalyst 72 that has been cooled after long-term parking, and is set as a state of charge in which the amount of charge necessary for hybrid vehicle 1 to travel, that is, the amount of charge that allows traveling until heating of the catalyst is completed is secured and further heating of catalyst 72. Specifically, threshold value P1 is determined in consideration of the activation temperature of the catalyst and the outside air temperature. After the heating is completed, the output of the engine can be increased for charging, thereby avoiding the deterioration of exhaust gas. Threshold value P1 may be set to different values depending on, for example, the outside air temperature. When the SOC is equal to or greater than threshold value P1 (No in Step S3), the SOC does not need to be further increased, and thus the process proceeds to SOC maintaining control in Step S7 described below.

On the other hand, when the SOC is less than threshold value P1 (Yes in Step S3), processor 31 starts the charging control (Step S4). Here, the charging control is control to increase the SOC of battery 4 through travel and is control in which the output of engine 7 is increased to drive generator 8 with surplus output not used for traveling to charge battery 4, while the output of motor 9 is decreased to reduce power consumption.

Processor 31 determines whether the SOC of battery 4 is equal to or greater than threshold value P1 after the charging control is started (Step S5). When the SOC remains less than threshold value P1 (No in Step S5), the charging control is continued until the SOC becomes equal to or greater than threshold value P1.

Then, when the SOC of battery 4 is equal to or greater than threshold value P1 (Yes in Step S5), processor 31 stops the charging control (Step S6).

Once the SOC is secured at or above threshold value P1, processor 31 starts SOC maintaining control (Step S7). Here, the SOC maintaining control is control that maintains the SOC at the current level during traveling. For example, the output of engine 7 is set to a medium level and the output of motor 9 by battery 4 is set to a medium level, and the SOC level is maintained by making the amount of charge by power generation from the output of engine 7 and the amount of power consumption of battery 4 by the output of motor 9 equal to each other.

Processor 31 determines whether hybrid vehicle 1 has arrived at destination 2 (Step S8), continues the SOC maintaining control when hybrid vehicle 1 has not arrived at destination 2 (No in Step S8), and ends the process when hybrid vehicle 1 has arrived at destination 2 (Yes in Step S8).

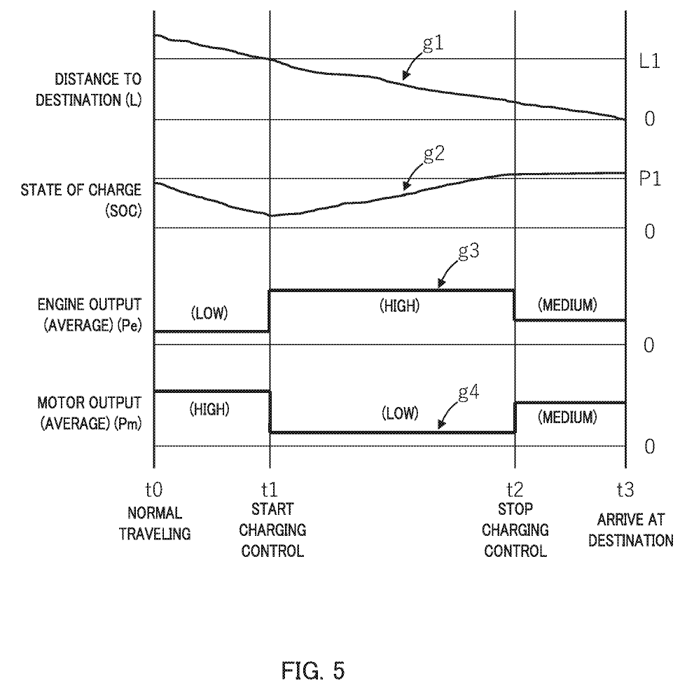

FIG. 5 is a graph illustrating time variations of the distance (L) to destination 2, a state of charge (SOC), an engine output (average) (Pe), and a motor output (average) (Pm) when hybrid vehicle 1 travels by the control of control device 3 to approach destination 2. The time progresses from left to right in the graph, and the vertical direction represents the value of each parameter.

At time point t = t0, in graph g1, hybrid vehicle 1 travels toward destination 2 at a position where distance L to destination 2 exceeds predetermined distance L1. At this time, in graph g2, state of charge SOC is slightly below threshold P1, but is sufficient for normal traveling. Since state of charge SOC is in a sufficient state, the engine output (average) (Pe) is in a relatively low state in graph g3, the motor output (average) (Pm) is in a relatively high state in graph g4, and state of charge SOC is declining in graph g2.

At time point t = t1, in graph g1, hybrid vehicle 1 has reached a position where distance L to destination 2 is predetermined distance L1. At this time, state of charge SOC is below threshold value P1 in graph g2. Thus, to increase state of charge SOC to P1, control device 3 starts the charging control in which the engine output (average) (Pe) is set to a relatively high state in graph g3 and the motor output (average) (Pm) is set to a relatively low state in graph g4 . By starting the charging control, state of charge SOC changes from the previous decreasing tendency to an increasing tendency in graph g2.

At time point t = t2, in graph g1, the distance of hybrid vehicle 1 to destination 2 is further reduced, and at this time, state of charge SOC exceeds threshold value P1 in graph g2. Thus, control device 3 performs the SOC maintaining control in which the engine output (average) (Pe) is set to an intermediate state in graph g3 and the motor output (average) (Pm) is set to an intermediate state in graph g4 to maintain state of charge SOC at a level exceeding P1 until hybrid vehicle 1 arrives at destination 2, and continues the traveling. Accordingly, state of charge SOC is maintained substantially constant in graph g2.

Then, at t = t3, hybrid vehicle 1 arrives at destination 2, and at this time, state of charge SOC maintains a value exceeding threshold value P1.

As described above, state of charge SOC exceeds threshold value P1 when hybrid vehicle 1 arrives at destination 2 where long-term parking is expected, so that it is not necessary to continue the operation of engine 7 to charge battery 4 after arriving at destination 2.

### Variation

In the above-described embodiment, the case has been described where the destination set in navigation device 10 is a place where long-term parking is expected, but destination 2 does not need to be set in navigation device 10. For example, past travel records may be used to extract locations where a vehicle was parked for long periods, and those locations may be set in advance as locations where long-term parking is expected. Accordingly, even when destination 2 is not set in navigation device 10, the SOC can be set to threshold value P1 or greater before arriving at the point where long-term parking is expected.

In addition, the user may set the point where long-term parking is expected in advance. This allows state of charge SOC to be reliably set to threshold value P1 or greater when the vehicle arrives at the point where long-term parking is expected.

In the above-described embodiment, the charging control of battery 4 is performed based on the distance to the point where long-term parking is expected, but the charging control of battery 4 may be performed based on the required time to reach destination 2 instead of the distance. That is, a time (also referred to as predetermined time) for securing the necessary amount of charge may be calculated, and the charging control may be started based on the required time to reach destination 2.

As described above, state of charge SOC is checked when hybrid vehicle 1 approaches distance L1 to destination 2, and the engine output and the motor output are controlled to exceed threshold value P1 in the case that state of charge SOC is lower than threshold value P1, so that state of charge SOC exceeds threshold value P1 when hybrid vehicle 1 arrives at destination 2. Therefore, state of charge SOC sufficient for heating catalyst 72 by heating device 5 after long-term parking is secured at the time of arriving at destination 2, and thus it is not necessary to continue the engine operation after arriving at destination 2 to charge battery 4. Furthermore, when long-time parking is not expected, it is not necessary to charge battery 4 beyond a state necessary for traveling, so that fuel economy can be improved and deterioration of battery 4 can be suppressed.

### Industrial Applicability

The present disclosure can be suitably applied as control device 3 for battery 4 of hybrid vehicle 1.

What is claimed is:

1. A hybrid vehicle, comprising:
an engine;
a battery;
a generator for charging the battery;
a catalyst that purifies exhaust gas of the engine;
a heating device that heats the catalyst by electric power of the battery; and
a processor that controls driving of the generator, wherein
the processor controls the driving of the generator such that an amount of charge of the battery is equal to or greater than a predetermined threshold value before arrival at a destination where parking for a predetermined duration or longer is expected, and
the threshold value is an amount of charge capable of supplying electric power necessary for heating, by the heating device, the catalyst cooled by the parking for the predetermined duration or longer.

2. The hybrid vehicle according to claim 1, wherein
the processor acquires the amount of charge of the battery when a distance to the destination is equal to or shorter than a predetermined distance, and
the processor controls the driving of the generator based on the acquired amount of charge.

3. The hybrid vehicle according to claim 1, wherein
the processor acquires the amount of charge of the battery when a required time to reach the destination is equal to or shorter than a predetermined time, and
the processor controls the driving of the generator based on the acquired amount of charge.

4. The hybrid vehicle according to claim 1, wherein
the processor acquires the amount of charge of the battery when the hybrid vehicle enters a charging area set around the destination, and
the processor controls the driving of the generator based on the acquired amount of charge.

5. The hybrid vehicle according to claim 1, wherein
the generator is driven by the engine, and
the processor controls driving of the engine to control the generator.

6. The hybrid vehicle according to claim 1, wherein
the generator is a drive motor to which electric power is supplied from the battery, and
the generator generates electric power using regenerative energy during deceleration.

7. The hybrid vehicle according to claim 1, further comprising a navigation device, wherein
the processor sets, as the destination, a destination set in the navigation device.

8. The hybrid vehicle according to claim 1, further comprising a storage device that stores a travel record including a parking location and a parking duration at the parking location, wherein
the processor sets, as the destination, the parking location where the parking duration is equal to or longer than the predetermined duration among a plurality of the parking locations stored in the storage device.

9. The hybrid vehicle according to claim 1, wherein
the destination is settable by a user.

10. The hybrid vehicle according to claim 1, wherein
the processor sets the threshold value based on an outside air temperature.
